(19) United States
(12) Patent Application Publication
(10) Pub. No.: US 2005/0271436 A1
(43) Pub. Date: Dec. 8, 2005

(54) Document feeder

(76) Inventors: Justine Worley, Murrieta, CA (US); Kevin Bokelman, San Diego, CA (US); Long C. Doan, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/859,287

(22) Filed: Jun. 2, 2004

(51) Int. Cl. G03G 15/00

(52) U.S. Cl. 399/367

(57) ABSTRACT

One embodiment of a document feeder comprises a chassis that includes an outer surface that defines a path that changes a direction of a media by at least 90° and an inner surface that defines a chassis cavity, and a roller positioned at least partially within said cavity for advancing a media at least partially along the path.

### BACKGROUND

Imaging systems, for example, printers, copiers, scanners and facsimile machines, may include a document feeder for picking and then feeding an original document to an imaging device and then ejecting the original document into an output location, such as onto an output tray, after imaging the document. It may be desirable that the imaging system be small, inexpensive to produce, and quiet, while having adequate speed and adequate ability to feed a variety of original document materials and sizes.

### BRIEF DESCRIPTION OF THE DRAWINGS

FIG. 1 is a side cross-sectional view of one embodiment of an imaging system including one embodiment of a document feeder.

FIG. 2 is an isometric view of one embodiment of a document feeder having a prepick mechanism mounted thereon.

FIG. 3 is an isometric view of one embodiment of an upper document guide structure.

FIG. 4 is an isometric view of one embodiment of a lower document guide structure.

FIG. 5 is an isometric view of one embodiment of a drive assembly.

FIG. 6 is an exploded view of one embodiment of a drive assembly.

FIG. 7 is a schematic of one embodiment of an imaging system.

### DETAILED DESCRIPTION OF THE DRAWINGS

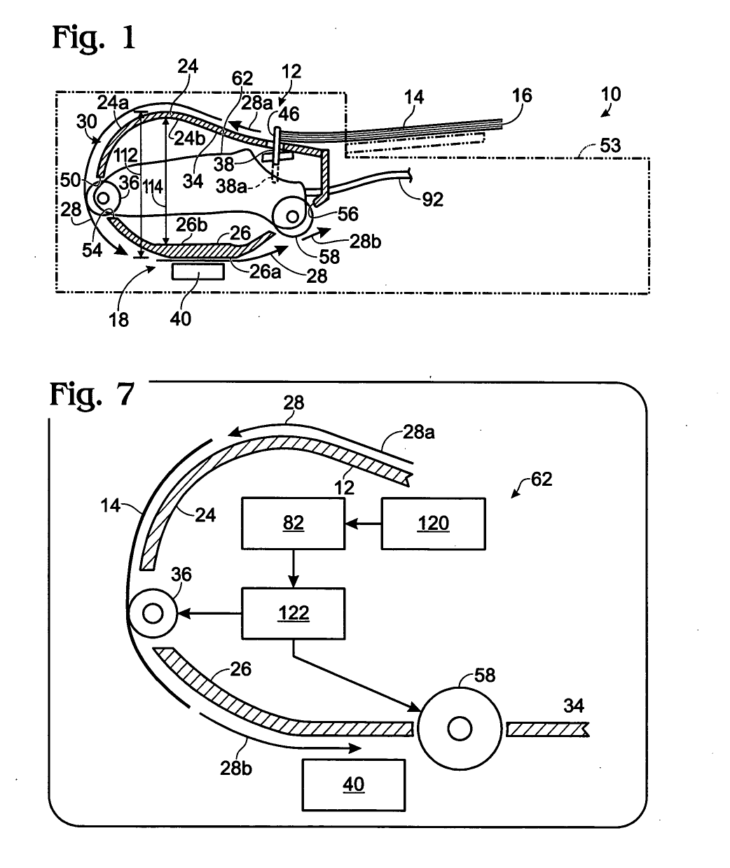

FIG. 1 is a side cross-sectional view of one embodiment of an imaging system 10 including one embodiment of a document feeder. Imaging system 10 may comprise, for example, a printer, a copier, a scanner and/or a facsimile machine, or any combination thereof. Imaging may comprise, for example, printing, copying, scanning or faxing a document. Imaging system 10 may include a document feeder 12, such as an automatic document feeder (ADF) that may allow positioning of an original printmedia, such as a sheet 14, and/or a stack 16 of sheets, for feeding to an imaging zone 18 within system 10. In one embodiment, sheet 14 may comprise a single sheet of paper. However, the printmedia may be any type of printmedia material suitable for imaging, such as cardboard, fabric, mylar, transparency slides, photographic paper, or the like.

FIG. 2 is an isometric view of one embodiment of document feeder 12 having a prepick mechanism 20 mounted thereon. Document feeder 12 may comprise a guide structure such as a chassis 22 including an upper chassis 24 and a lower chassis 26. An outer surface 24a of upper chassis 24 and an outer surface 26a of lower chassis 26 together may define a printmedia path 28 iii including imaging zone 18. In the embodiment shown, printmedia path 28 may define a generally “U” shaped bend in a bend region 30, wherein the “U” shaped bend may define a curvature 32 of 90° or more, such as a curvature of 180°, such that sheet 14 starts in a first direction 28a and ends in a second direction 28b, approximately 180° from first direction 28a. Sheet 14 may be retained in path 28 around chassis 22 by rollers (not shown) or other types of guide structure(s). Upper chassis 24 may include an inner surface 24b and lower chassis 26 may define an inner surface 26b that together define a hollow interior or a cavity 34 (see FIG. 1) of document feeder 12.

A drive roller 36 may be positioned within cavity 34 of of document feeder 12 and may extend at least partially outwardly from inside chassis 22, and into printmedia path 28 for feeding of sheet 14 along printmedia path 28. In the embodiment shown, drive roller 36 may comprise a pre-imaging roller such as a pre-scan roller. For example, roller 36 may contact the media at a position upstream, i.e., a pre-scanned position, from where the media may be scanned in imaging zone 18. A printmedia gate structure 38 may also be positioned within cavity 34 of document feeder 12 and may extend at least partially outwardly from inside chassis 22 and into printmedia path 28 in a raised or closed position. In a lowered or open position, shown as dash lines 38a (see FIG. 1), gate 38 may be positioned completely within cavity 34 so as to not obstruct sheet 14 at it is driven along printmedia path 28. An imaging device 40 (see FIG. 1), for example, an inkjet printhead, a scanning device, or the like, may be positioned in or adjacent to printmedia path 28 and adjacent chassis 22.

FIG. 3 is an isometric view of one embodiment of upper chassis 24 including outer surface 24a and inner surface 24b. Chassis may include apertures 42 positioned in a document input region 44 of document feeder 12. Apertures 42 may allow the extension of arms 46 (see FIG. 1) of gate 38 therethrough, wherein gate arms 46 may extend upwardly into printmedia path 28 in a raised or closed gate position, and arms 46 may be positioned completely within cavity 34 (see FIG. 1), and not extend into printmedia path 28, in a lowered or open gate position. Upper chassis 24 may further include apertures 48 for receiving fasteners (not shown) for securing upper chassis 24 to lower chassis 26 (see FIG. 1). Upper chassis 24 may also include a cutout region 50 for the extension of drive roller 36 (see FIG. 1) therethrough, or a portion of drive roller 36 therethrough, and into printmedia path 28. The roller 36 is mounted on a shaft 84, which is disposed entirely within the cavity 34. The roller 36 is at least partially disposed in the cavity 34.

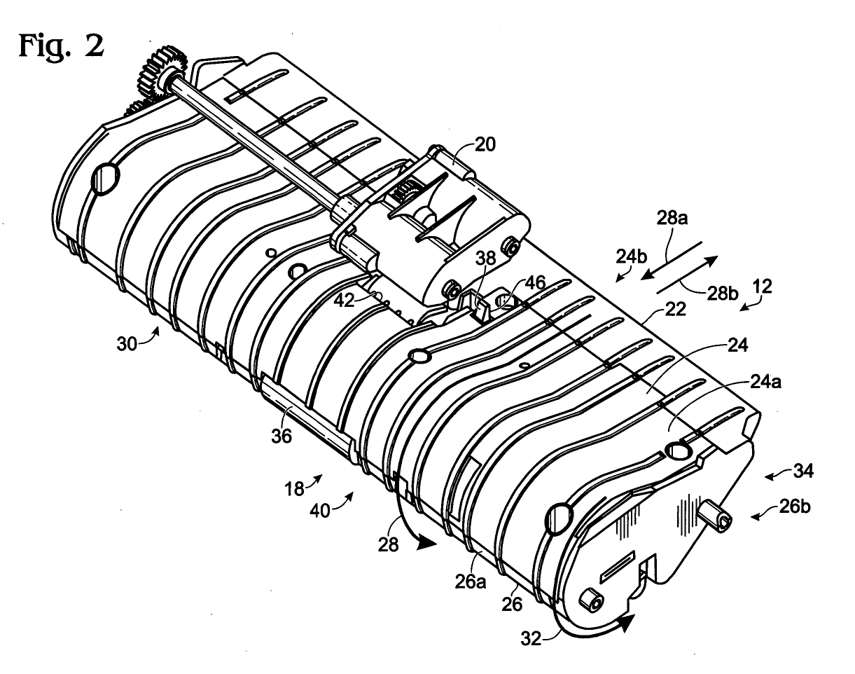

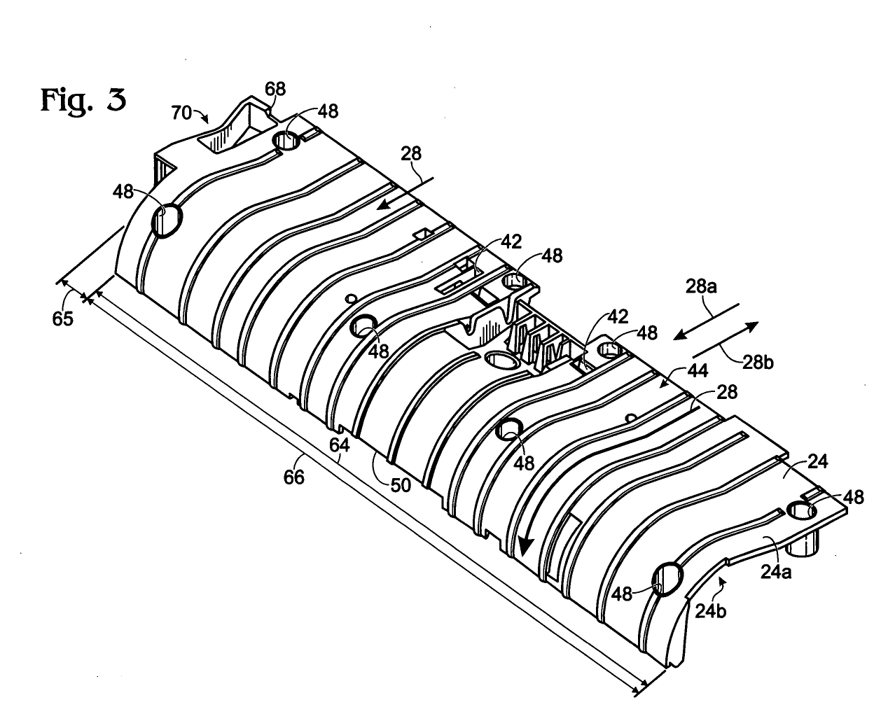

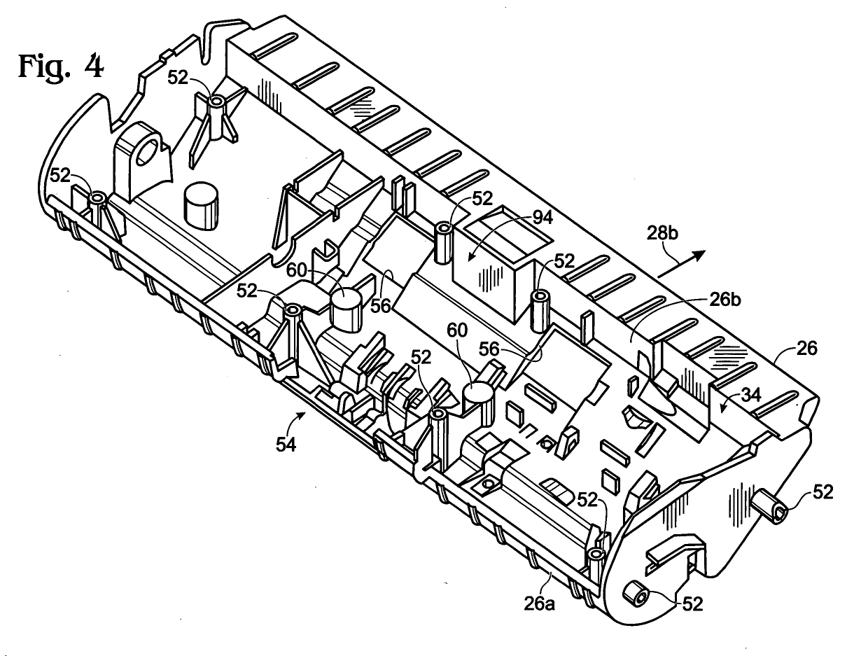

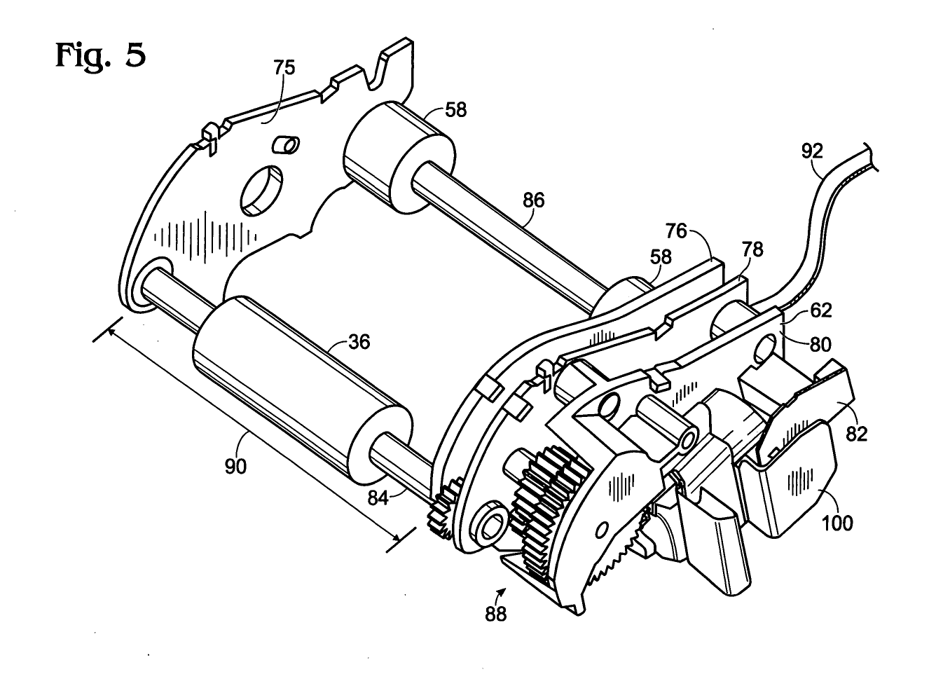

FIG. 4 is an isometric view of one embodiment of lower chassis 26 including outer surface 26a and inner surface 26b. Lower chassis 26 may include fastener receiving apertures 52 for receiving fasteners therein (not shown), so as to secure upper chassis (see FIG. 3) and lower chassis 26 to one another. Lower chassis 26 may include outwardly extending tabs 52 for securing chassis 22 within a housing 53 (see FIG. 1) of imaging system 10. Lower chassis 26 may also including a cutout region 54 for the extension of drive roller 36 (see FIG. 1) therethrough, or a portion of drive roller 36 therethrough, and into printmedia path 28. Lower chassis 26 may further include apertures 56 fofo r the extension of postscan drive rollers 58 (see FIG. 5) therethrough, or a portion of drive rollers 58 therethrough, and into printmedia path 28. For example, rollers 58 may contact the media at a position downstream, i.e., a post scanned position, from where the media may be scanned in imaging zone 18. Lower chassis 26 may also include support structures, such as posts 60, for supporting and securing thereto a drive assembly 62 (see FIG. 5).

Referring to FIGS. 3 and 4, upper chassis 24 and lower chassis 26 may each define a width 64 wherein width 64 may be substantially the same as a width 66 of printmedia path 28. In particular, upper chassis 24 may include a guide surface 68 positioned in an edge region 70 of upper chassis 24, wherein guide surface 68 may define an outer edge of printmedia path 28 such that a document feed along printmedia path 28 will be in contact with and aligned by guide surface 68. In other words, width 64 of chassis 22 may be defined by width 66 of printmedia path 28 plus a width 65 of guide surface 68. Width 65 may be quite small, such as 1/16 of an inch or less. Width 66 may be the width of a standard sheet of paper, such as 8½inches. According, in one embodiment, width 64 of chassis 22, and therefore, the width of imaging system 10, may be approximately 8 and 9/16 inches, substantially the same, as width 66 of printmedia path 28. This relatively narrow width of imaging system 10 may be achievable due to the positioning of drive assembly 62 (see FIG. 5) within chassis 22.

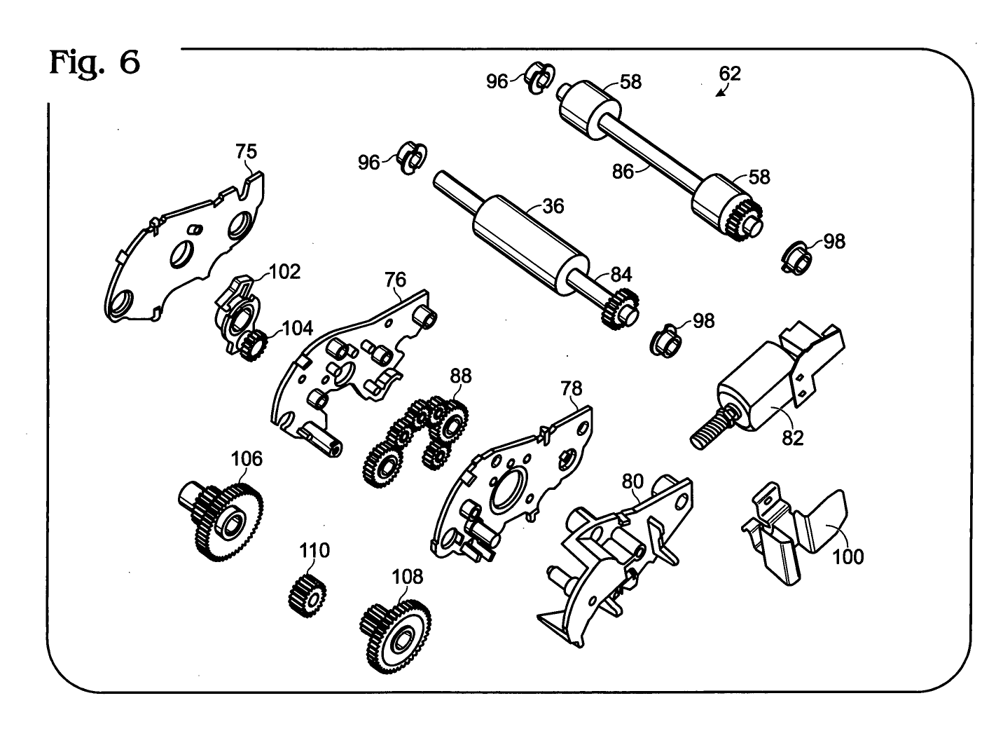

FIGS. 5 and 6 are an isometric view and an exploded view, respectively, of one embodiment of drive assembly 62. Drive assembly 62 may include a scan drive bracket 75, an outer transmission bracket 76, a middle transmission bracket 78, and a motor bracket 80. A motor 82, such as a DC servo motor, may be secured to motor bracket 80 and may be connected to a pre-imaging drive shaft 84 and to a post-imaging drive shaft 86 via a gear train assembly 88. Pre-imaging drive roller 36 may be mounted on pre-imaging drive shaft 84 and may extend at least partially through cutout regions 50 and 54 of upper and lower chassis structures 24 and 26, respectively, (see FIGS. 3 and 4) and into printmedia path 28. Post-imaging drive rollers 58 may be mounted on post-imaging drive shaft 86 and may extend at least partially through apertures 56 of lower chassis structure 26 (see FIG. 4) and into printmedia path 28.

Drive shafts 84 and 86 may be driven by motor 82 through connection to gear train assembly 88 such that drive rollers 36 and 58 are driven by motor 82. Drive shafts 84 and 86 may be connected to scan bracket 75 by bearings 96 and to middle transmission bracket 78 by bearings 98. Motor 82 may be secured to motor bracket 80 by a motor clamp 100. Gate 38 may be actuated by a swingarm 102 that is connected by a pinion gear 104 to gear train assembly 88. A drive gear 106 may be mounted on motor bracket 80 for driving drive shafts 84 and 86 through connection to gear train assembly 88. A second drive gear 108 may be mounted on middle transmission bracket 78 for driving drive shafts 84 and 86 through connection to an idler gear 110 and gear train assembly 88 when drive gear 106 is not engaged with motor 82.

Drive assembly 62 may be connected to a remainder of imaging system 10 by an electrical connection such as by a flat, flexible cable 92. Due to the positioning of drive assembly 62 within cavity 34, flexible cable 92 may extend outwardly from cavity 34 through a central region 94 (see FIG. 4) of width 66 of printmedia path 28. The centrally located electrical connection from document feeder 12 to a remainder of imaging system 10 may reduce manufacturing costs of imaging system 10 and may help shield the sensitive electronics of document feeder 12 from electrostatic discharge.

Drive shafts 84 and 86 may be manufactured of steel or other such like durable material. The drive shafts may each have a length 90 not greater than a width 64 (see FIG. 3) of upper and lower chassis structures 24 and 26, respectively, and not greater than width 66 (see FIG. 3) of printmedia path 28. In the embodiment shown, drive shafts 84 and 86 each have a length 90 of approximately half of width 66 of printmedia path 28, such as a length 90 of approximately four inches. Accordingly, drive shafts 84 and 86 may be manufactured with less material than previously manufactured drive shafts, such that drive shafts 90 of the present invention may be manufactured at a reduced cost when compared to drive shafts of previously manufactured imaging systems.

Referring again to FIG. 1, chassis 22 may have a height 112 in bend region 30 in a range of approximately one to three inches, and more particularly, in a range of approximately 1.5 to 2 inches. In an embodiment wherein bend region 30 defines a circular curvature, height 112 may define a diameter of bend region 30 of chassis 22. Cavity 34 may have a height 114 of approximately slightly less than one to three inches, wherein height 114 may be sufficient for positioning of drive assembly 62 completely within cavity 34 of document feed structure 12. The space defined by cavity 34, therefore, is not wasted space. In other words, the space defined by cavity 34 may be utilized for the positioning of drive assembly 62 such that additional space within imaging system 10 is not required for the positioning of drive assembly 62. For this reason, chassis 22 may be manufactured in a size larger than previously manufactured imaging systems, such that bend region 30 may have a larger curvature, than a previously manufactured chassis, so as to allow increased speed of a document as it is moved along printmedia path 28 and through bend region 30. An increased size of the curvature of bend region 30 of chassis 22 may also allow an increased ability of document feeder 12 to feed a variety of original printmedia materials and sizes, such as relatively stiff materials and large sizes of printmedia. Due to the positioning of drive assembly 62 within cavity 34, overall imaging system 10 (see FIG. 1) may be manufactured in a small size and at an inexpensive cost then previously manufactured imaging systems. Furthermore, due to the inclusion of drive assembly 62 within chassis 22, noise generated by drive assembly 62 during operation may be muffled by chassis 22 such that imaging system 10 may have a quiet noise output when compared to previously manufactured imaging systems.

Drive assembly 62 may be contained completely within cavity 34 of chassis 22 such that the components of drive assembly 62 are positioned within width 64 of chassis 22 and within width 66 of printmedia path 28. Accordingly, imaging system 10 may be manufactured in a width substantially the same as or only slightly larger than width 64 of chassis 22. Moreover, drive assembly 62 and/or chassis 22 having drive assembly 62 positioned therein, may be manufactured as a single, removable unit thereby reducing repair or replacement costs of the drive assembly and or the chassis. In another embodiment, chassis 22 may be manufactured such that the motor and transmission brackets of drive assembly 62 may be integral with chassis 22, for example, such as defining the end wall structures of lower chassis 26. In such an embodiment, drive shafts 84 and 86 may be positioned extending into the end wall structures but not extending therethrough such that the drive shafts may have a length contiguous with, but not longer than, a width of chassis 22.

FIG. 7 is a schematic of one embodiment of an imaging system 10 wherein a drive assembly 62 may include a controller 120, a motor 82, and a transmission 122, which may be connected as shown. Transmission 122 may be connected to rollers 36 and 58.

Other variations and modifications of the document feeder may be utilized wherein such variations and modifications of the concepts described herein fall within the scope of the claims below.

1. A document feeder, comprising:
a chassis that includes an outer surface that defines a path that changes a direction of a media by at least 90° and an inner surface that defines a chassis cavity; and
a roller positioned at least partially within said cavity for advancing a media at least partially along the path.

2. A document feeder according to claim 1 further comprising a motor drive assembly positioned completely within said cavity and including a motor, a transmission and a controller.

3. A document feeder according to claim 1 further comprising a document stop gate positioned completely within said cavity in a lowered position and extending outwardly of said cavity and into said path in a raised position.

4. A document feeder according to claim 1 further comprising a drive roller mounted on said drive shaft wherein a portion of said drive roller is positioned within said cavity and another portion of said drive roller extends outwardly of said cavity and into said document path.

5. A document feeder according to claim 4 wherein said drive roller is chosen from the group consisting of a prescan roller and a postscan roller.

6. A document feeder according to claim 1 wherein said path defines a width and wherein said drive shaft has a length not greater than said width.

7. A document feeder according to claim 1 wherein said chassis includes an upper chassis that defines a document input to said path, and a lower chassis that defines a document output from said path.

8. A document feeder according to claim 1 wherein said path changes a direction of a media by approximately 180°.

9. An imaging system, comprising:
a guide structure including an exterior that defines a path having a curvature of at least 90°; and
a motor po positioned within and not extending outwardly from said guide structure.

10. An imaging system according to claim 9 further comprising an imaging device positioned adjacent said guide structure, wherein said imaging device is chosen from the group consisting of a facsimile device, a scanner, and a printhead.

11. An imaging system according to claim 9 wherein said path defines a 180° curvature.

12. An imaging system according to claim 9 further comprising a stop gate positioned completely within a hollow interior of said guide structure in a lowered position and extending outwardly of said hollow interior in a raised position.

13. An imaging system according to claim 9 further comprising a drive roller driven by said motor to move a sheet of printmedia along said path.

14. An imaging system according to claim 9 further comprising a drive shaft positioned completely within a hollow interior of said guide structure wherein said drive shaft is driven by said motor.

15. An imaging system according to claim 9 wherein said guide structure includes an upper chassis that defines a media input region of said path, and a lower chassis that defines a media output region of said path.

16. An imaging system according to claim 9 wherein said guide structure is a component of an automatic document feeder.

17. An imaging system according to claim 9 wherein said guide structure has a width substantially the same as a width of said path.

18. An imaging system according to claim 9 wherein said path defines a width and said imaging system further comprises an electronic connection port electrically connected to said drive assembly and positioned within said width.

19. An imaging system according to claim 18 wherein said electronic connection portion comprises a flexible cable, and wherein said guide structure with said motor positioned completely therein comprises a replaceable unit removably secured within said imaging system.

20. An imaging system according to claim 15 wherein said document input region includes a document prepick assembly.

21. A document feeder, comprising:
means for guiding a media along a feed path that changes a direction of the media by at least 90°, said means for guiding defining a hollow cavity within a region wherein said path changes a direction of the media; and
means for driving a media along said feed path, said means for driving contained wholly within said hollow cavity.

22. A document feeder according to claim 21 wherein said means for guiding includes an outer surface that defines said feed path.

23. A document feeder according to claim 21 wherein said means for driving includes a motor and a drive shaft driven by said motor, and said document feeder further comprises a drive roller mounted on said drive shaft.

24. A document feeder according to claim 21 wherein said feed path changes a direction of a media by approximately 180°.

25. An imaging apparatus, comprising:
a guide structure that includes an exterior surface that defines a path and an interior surface that defines a cavity;
a drive roller positioned at least partially within said cavity and extending at least partially into said path so as to move a media along said path; and
a motor positioned completely within said cavity, said motor drivingly engaged with said drive roller.

26. An imaging apparatus according to claim 25 further comprising an imaging device positioned adjacent said path and chosen from the group consisting of a scanner, a facsimile device and a printhead.

27. An imaging apparatus according to claim 25 further comprising a drive shaft positioned completely within said cavity, said drive shaft driven by said motor and having said drive roller mounted thereon.

28. An imaging system, comprising:
a g guide structure including an exterior that defines a path having a curvature of at least 90°; and
a controller positioned within and not extending outwardly from said guide structure.

29. A document feeder, comprising:
a chassis that includes an outer surface that defines a path that changes a direction of a media by at least 90° and an inner surface that defines a chassis cavity; and
a transmission positioned wholly within said cavity for advancing media at least partially along the path.

30. An imaging apparatus, comprising:
a guide structure that includes an exterior surface that defines a path and an interior surface that defines a cavity;
a drive roller positioned at least partially within said cavity and extending at least partially into said path so as to move a media along said path;
a motor positioned completely within said cavity, said motor for powering said drive roller; and
a transmission positioned completely within said cavity, said transmission connecting said drive roller and said motor.
